(19) United States
(12) Patent Application Publication
(10) Pub. No.: US 2012/0034432 A1
(43) Pub. Date: Feb. 9, 2012

(54) COMPOSITE ABSORBENT MATERIALS AND METHODS FOR THEIR PRODUCTION

(75) Inventor: Stephen Cotton, Nottinghamshire (GB)

(73) Assignee: BRIGHTWAKE LIMITED, Nottingham, Nottinghamshire (GB)

(21) Appl. No.: 13/262,316

(22) PCT Filed: Mar. 30, 2010
(86) PCT No.: PCT/GB2010/050538

§ 371 Date: Sep. 30, 2011

(30) Foreign Application Priority Data
Mar. 30, 2009 (GB) 0905341.4

(51) Int. Cl. B32B 3/00; B29C 65/08; B32B 37/06

(52) U.S. Cl. 428/195.1; 156/73.1

(57) ABSTRACT

A composite absorbent material (1) comprising one or more absorbent layers (6) and one or more reinforcing layers (4) bonded together, and method of manufacture. The reinforcing layers (4) maintain the structural integrity of the material following fluid absorption. The composite absorbent material (1) may form the absorbent component of an absorbent wound dressing.

The present invention relates to a method for producing composite absorbent materials, and to absorbent materials that may be produced by that method. More particularly, the present invention relates to the attachment of reinforcing layers to superabsorbent material so that it maintains its mechanical strength upon fluid absorption.

Standard superabsorbers such as sodium polyacrylate polymer and alginate substantially soften and lose their mechanical strength upon fluid absorption. This loss of mechanical strength can be particularly undesirable when superabsorbent materials are used in certain applications, such as wound dressings. When dressings formed of superabsorbent materials, such as alginate, are changed, it is necessary to remove the old dressing in its entirety before it is replaced. However, the loss of mechanical strength may lead to disintegration of the dressing and this in turn may cause complications during re-dressing, resulting in pain and trauma for the patient. In addition to this, when a superabsorbent material is used in combination with, for example, medical devices, the disintegration of the superabsorbent material may cause clogging of the device, or be otherwise problematic.

Absorbent materials such as superabsorbers may be used in composite absorbent wound dressings, such as the dressing described in GB patent application No 0906056.7. In such dressings, a layer of superabsorbent material may be present within an internal compartment of the dressing, and as this material takes up wound exudate it may lose its mechanical strength and collapse, an effect commonly referred to as “slumping”. In such cases, the absorbent material will not remain evenly distributed throughout the dressing, reducing its effectiveness in absorbing wound exudate. This is particularly problematic when the dressings are disposed vertically in use, as in this case the absorbent material may have a particular tendency to slump to the lower end of the internal compartment of the dressing.

Standard methods for preventing slumping involve the use of a suitable carrier material to which the superabsorbent material can be fixed or in which it can be encapsulated. However, these methods generally require the use of adhesives, which interfere with the moisture vapor transmission rate (MVTR) and absorbency of the superabsorbent material and may also cause toxicity where the superabsorber is placed in contact with living tissue as with, for example, a wound dressing. Alternatively, a superabsorber may be reinforced by a fibre support network within the superabsorbent material itself. This may also be unsatisfactory, since the loss of mechanical strength experienced by the superabsorbent material when fluid is absorbed can lead to the superabsorbent material becoming detached from the support network. There is therefore a requirement for a method for reinforcing superabsorbent materials to prevent slumping and allow the superabsorbent material to maintain mechanical strength upon fluid absorption.

There has now been devised an improved method for reinforcing superabsorbent materials which overcomes or substantially mitigates the above-mentioned and/or other problems associated with the prior art.

According to the first aspect of the invention, there is provided a method of producing a composite absorbent material, which method involves forming a layered arrangement of one or more absorbent layers and one or more reinforcing layers, and using high frequency mechanical vibrations to weld at least two of the layers together in order to produce a composite absorbent material.

Typically, the method of the invention will produce an absorbent material comprising at least one absorbent layer and at least one reinforcing layer, in which at least two layers are welded together at a plurality of weld points.

Thus, in another aspect, the invention provides a composite absorbent material comprising a layered arrangement of one or more absorbent layers and one or more reinforcing layers, in which at least two of the layers are welded together at a plurality of weld points.

The composite absorbent material and method of the present invention are advantageous primarily in that the layers are effectively bonded together, and the reinforcing layers act to maintain the mechanical strength and integrity of the material, when the absorbent layer absorbs fluid. The problem of “slumping” of the absorbent material is thereby overcome or substantially mitigated.

The invention is particularly applicable to the use of absorbent materials of the types commonly referred to as “superabsorbers” or “superabsorbent materials”. Such materials are typically polymers that are capable of absorbing and retaining extremely large quantities of fluid relative to their own mass.

Typically, such materials absorb aqueous solutions through hydrogen bonding with water molecules, and may absorb up to 200, 400, or 500 times or more of their weight of water.

Amongst the most commonly used superabsorbent polymers are polyacrylates, ie salts of polyacrylic acid. For instance, the sodium salt of polyacrylic acid (cross-linked sodium polyacrylate) may be produced by the polymerization of acrylic acid blended with sodium hydroxide in the presence of an initiator.

Other superabsorbent polymers include polyacrylamide copolymer, ethylene maleic anhydride copolymer, cross-linked carboxymethylcellulose, polyvinylalcohol copolymers, cross-linked polyethylene oxide, starch-grafted copolymers of polyacrylonitrile, and others.

Another class of superabsorbent polymer that may be used in the invention is alginate, ie salts of alginic acid. Such material occurs naturally as a viscous gum that is abundant in the cell walls of brown algae, and commercial forms are extracted from seaweed. Alginic acid is a linear copolymer with homopolymeric blocks of (1-4)-linked•-D-mannuronate and its C-5 epimer•-L-guluronate residues, covalently linked together in different sequences or blocks.

Alginates that are particularly suitable for use in the present invention are calcium alginate and sodium alginate.

Although it is preferred that the absorbent and reinforcing layers in the layered arrangement alternate so that adjacent layers are different, the layered arrangement may have any combination of layers, provided the layers may be welded together.

Although it is possible for the method of the present invention to be carried out on a layered arrangement comprising numerous absorbent layers and reinforcing layers, preferred embodiments have a layered arrangement having no more than two absorbent layers and no more than two reinforcing layers.

In particularly preferred embodiments of the method of the present invention, the layered arrangement comprises three layers, in the form of an inner layer sandwiched between two outer layers that are different to the inner layer and similar to each other.

Therefore, in one particularly preferred embodiment of the method of the present invention, the layered arrangement is formed with a single absorbent layer sandwiched between two reinforcing layers. The composite absorbent material thereby produced comprises an inner absorbent layer encapsulated between two outer reinforcing layers. This arrangement is particularly desirable when superabsorbers such as sodium polyacrylate polymer are used, which become particularly soft upon fluid absorption. In this case, it is preferable to have the superabsorbent layer sandwiched between reinforcing layers in order to encapsulate the superabsorbent and prevent its separation from the composite absorbent material upon fluid absorption and loss of its mechanical strength.

In another particularly preferred embodiment of the method of the present invention, the layered arrangement is formed with a single reinforcing layer sandwiched between two absorbent layers. The composite absorbent material thereby produced comprises a reinforcing layer bound on both major surfaces by absorbent layers. This arrangement is particularly desirable when superabsorbers such as sodium or calcium alginate are used, which remain relatively firm upon fluid absorption. Such superabsorbers are less able to deform around reinforcing layers when they expand upon fluid absorption. In addition to this, superabsorbers that retain some mechanical strength upon fluid absorption are less in need of reinforcement and can therefore be exposed on the surface of the composite absorbent material.

The application of high frequency mechanical vibrations to a layered arrangement of material is able to bring about the generation of localised heat by friction. Where the layered arrangement contains a material that fuses when heated, this heat causes the welding of those layers together to form a composite absorbent material. The layered arrangement must therefore contain a material that fuses when heated, preferably a thermoplastic such as polyester, polypropylene or nylon. In preferred embodiments, it is the reinforcing layer or layers that are formed of material that fuses when it is heated.

The high frequency mechanical vibrations required to weld the layered arrangement together are preferably applied to the material using a device of the type commonly used in ultrasonic welding. These devices are typically used to weld thermoplastic or fine metal components by applying high frequency mechanical vibrations to those components as they are held together under pressure. This combination of mechanical vibration and pressure results in the generation of heat by friction which is localised to the points at which the material is held under pressure. Welding materials with ultrasonics is of particular advantage in the medical industry because it does not introduce contaminants into the material, such as thread or adhesives. The use of ultrasonics is also advantageous over methods that involve the direct application of heat to the material because it is highly localised and controllable, and may be switched off instantaneously without any residual effect.

Ultrasonic welding machines generally consist of three main components: a converter which uses disks of piezoelectric material to convert electrical energy into high frequency vibrations, an amplitude modifier (referred to as a booster) which increases the amplitude of the vibrations, and a sonotrode (referred to as a horn) which transmits the vibrations to the material. Welding is carried out by applying vibrations to material held under pressure between the sonotrode and a holding surface (referred to as an anvil).

In one particularly preferred embodiment of the method of the invention, the layered arrangement is fed to a roller that has a multitude of regularly spaced flat-tipped pin-like projections on its surface. This so-called pin-roller and the sonotrode are configured so when the pin-roller is rotated, the tips of the pins pass close to the sonotrode surface. In operation, the layered arrangement is fed between the sonotrode and the pin-roller, and the tips of the pins act as points of increased pressure between the pin-roller and the sonotrode where welding can occur. In this way, the tips of the pins act as a multitude of individual holding surfaces or “anvils”. The separate layers of material are welded together at the points where the tips of the pins squeeze the layers together ie weld-points. The use of the pin-roller allows ultrasonic welding to be carried out as a continuous process and, because only the regions of the material that contact the tips of the pins are welded, the properties of the remaining material are preserved.

The pin-roller and sonotrode may be set to provide differing degrees of pressure between the tips of the pins and the sonotrode surface. This may result in the variation in the strength of the welds, or cause the pins to fully pierce the layered arrangement, producing a multitude of small apertures in the composite absorbent material.

The distribution and spacing of the weld-points correspond to the distribution and spacing of pin-like projections on the pin-roller. Weld-points are typically regularly arranged with a separation substantially greater than their diameter, although variation in the distribution of the weld-points is possible.

A greater density of weld points results in a more strongly bonded composite absorbent material, although too great a density may have a negative impact on the function of the composite absorbent material. This is particularly the case in embodiments of the composite absorbent material where the absorbent layer is sandwiched between two reinforcing layers. In this case, having a high density of weld points can restrict the swelling of the absorbent material as it takes up fluid. This can cause the absorbent material to be forced through the support layers as it swells, may cause breakage of the weld point, or otherwise compromise the integrity of the composite absorbent material.

Typically, weld points will be separated by between 5 mm and 30 mm, although where a large amount of swelling is expected, a separation of between 20 mm and 30 mm is preferred, while where a lesser amount of swelling is expected, a separation of between 10 mm to 15 mm may be used.

The size of the weld-points also corresponds to the shape of the cross section of the pin-like projections on the pin-roller. Weld-points may vary considerably in size, but are typically between 0.5 mm and 2 mm in diameter, although smaller and larger weld-points may be possible.

Where the composite absorbent material produced by the method of the present invention is intended for use as a wound dressing material, it is most preferably sterile so as not to introduce infective agents into the wound. Where the materials used are sensitive to heat, sterilisation methods using heat or pressure are not suitable. A more preferred method of sterilisation may be gamma irradiation or chemical sterilisation using agents such as ethylene oxide, both of which are widely used for the sterilisation of medical equipment.

The composite absorbent material produced by the method of this invention is typically in the form of a long strip. This strip may be wound onto a roll for supply to an end user or for storage as an intermediate product prior to use of the composite absorbent material in the manufacture of a finished product. The width of the strip generally does not exceed 200 mm, although the use of strips with greater widths is possible. However, sonotrodes having a width of greater than about 200 mm are less effective at applying high frequency mechanical vibrations to a material. Therefore, in order to produce strips of composite absorbent material having widths in excess of 200 mm, a number sonotrodes positioned adjacent to one another may be used.

Reinforcing layers must be formed of a material that is able to substantially maintain its mechanical strength when exposed to fluid. For many applications, reinforcing layers must also be permeable to liquid, to allow liquids to pass freely through to reach the absorbent material. Reinforcing layers are also preferably flexible so as not to restrict the conformability of the composite absorbent material.

Reinforcing layers preferably also provide the source of material that fuses when heated and in such cases are preferably formed of a thermoplastic material such as polyester, polypropylene or nylon.

Reinforcing layers are preferably of non-woven material. The most preferred form of non-woven material is thermally bonded non-woven material, the fibres of which are necessarily formed of material that fuses when heated. Forms of such material that are particularly preferred are porous, yet tough, flexible, light-weight and maintain their mechanical strength when exposed to fluid. The process of thermal bonding to produce non-woven materials does not involve the inclusion of potential contaminants into the material, such as adhesives or thread, making this material of particular advantage where the composite absorbent material is for use as a wound dressing.

A particular form of thermally bonded non-woven material that may be used as a reinforcing layer is non-woven polyester material sold under the trade name AEROFILL by Libeltex BVBA (Marialoopsteenweg 51, BE-8760 Meulebeke, Belgium).

Although it should be appreciated that the method of the present invention may be applied to any layered superabsorbent material, the most preferred superabsorbers are alginate and sodium polyacrylate polymer.

Alginate superabsorbent may be sodium or calcium alginate. The alginate superabsorbent is preferably in the form of a non-woven mat, providing a superabsorbent layer suitable for the method of the present invention.

Sodium polyacrylate polymer is a solid crystalline material, and is preferably incorporated into a layer with the crystals encapsulated between two layers of carrier material, such as tissue paper. A specific example of a suitable material is Gelok® 14040S/S manufactured by Gelok International Corporation.

In addition to absorbent and reinforcing layers, the layered arrangement may also incorporate additional layers for inclusion into the composite absorbent material. These additional layers may be present internally or on the surface of the composite absorbent material.

Where the composite absorbent material is for use as a wound dressing, it may be particularly advantageous to include materials such as a carbonised deodoriser or an anti-microbial. A preferred form of antimicrobial material is silver. Layers incorporating such materials are preferably included as inner layers of the composite absorbent material. The inclusion of these additional layers is most suitable in embodiments of the composite absorbent material where reinforcing layers form the outer layers.

In a particular embodiment of a wound dressing incorporating the composite absorbent material, the dressing contains one or more internal compartments in which the composite absorbent material may be present. In use, as the composite absorbent material takes up wound exudate, it is able to maintain its structural integrity to a greater extent than absorbent materials in general use. This prevents the composite absorbent material from collapsing or “slumping” and allowing the composite absorbent material remain more evenly spread across the wound site, improving its effectiveness in absorbing wound exudate.

This is particularly the case where the wound dressing is mounted vertically, where standard absorbent materials tend to slump to the bottom of the internal compartment as they take up fluid and lose their integrity.

In addition, the composite absorbent material may be of particular utility in absorbent wound dressings as the presence of the one or more reinforcing layers aids in the wicking of fluid throughout the composite absorbent material such that, if the composite absorbent material is in direct contact with the wound at only one point, the wound exudate is wicked to parts of the composite absorbent material not in direct contact with fluid, improving the absorbency of the wound dressing.

An impermeable film layer may also be present in the composite absorbent material to prevent the passage of fluid entirely through the material. This is particularly desirable where the composite absorbent material is for use as a wound dressing, as the passage of fluid or other agents from the wound to the outside environment, and vice versa, is undesirable. The impermeable film is preferably a polyurethane film. The impermeable film layer is preferably applied to the surface of the composite absorbent material and is preferably applied after the formation of the composite absorbent material to ensure that the film presents a continuous impermeable layer that is not compromised by the process of ultrasonic welding.

The present invention will now be described in greater detail, by way of example only, with reference to the accompanying drawings, in which

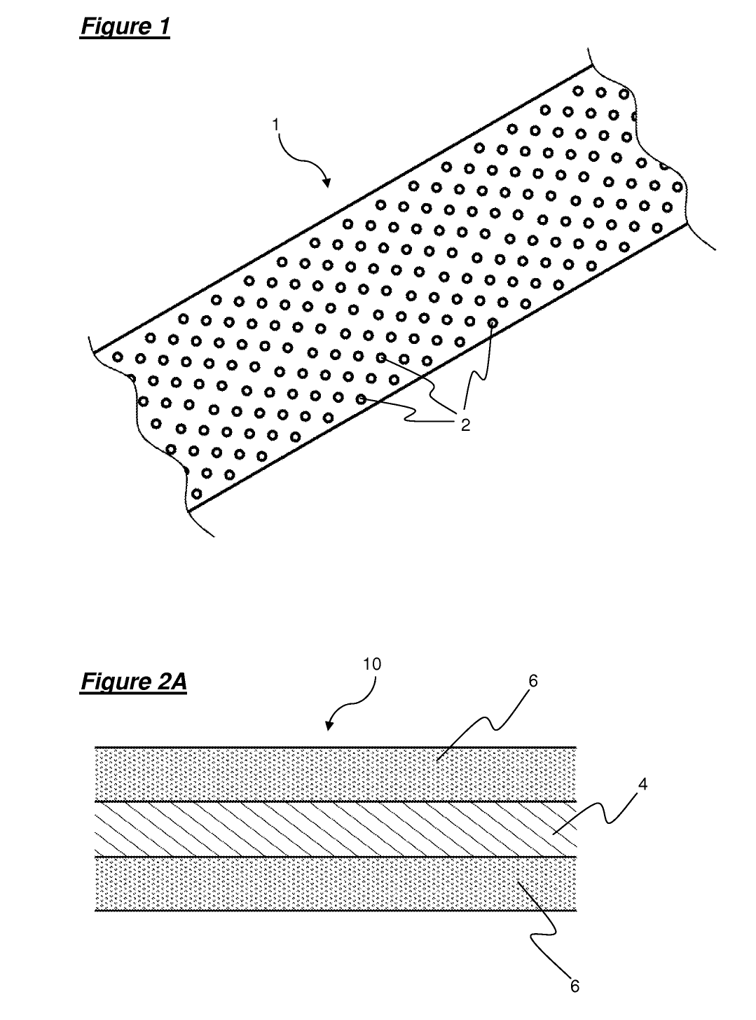

FIG. 1 is a plan view of a length of an embodiment of a composite absorbent material produced according to the method of the invention;

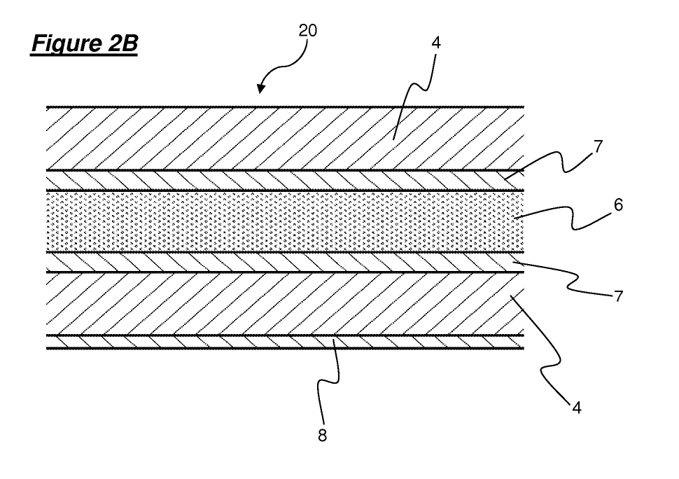

FIG. 2A is a cross-sectional view, schematic and not to scale, of a particular embodiment of a layer of composite absorbent material produced according to this invention;

FIG. 2B is a cross-sectional view, schematic and not to scale, of another particular embodiment of a layer of composite absorbent material produced according to this invention; and

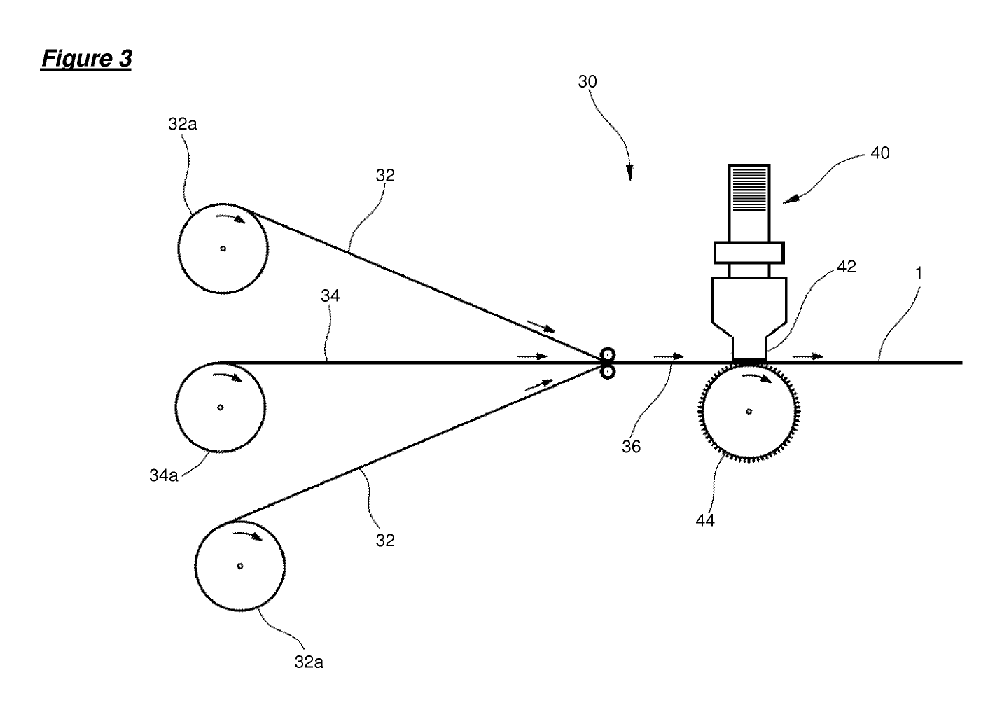

FIG. 3 is a schematic representation, not to scale, of an apparatus the may be used to produce the composite absorbent material of FIGS. 1, 2A and 2B.

Referring first to FIG. 1, a general embodiment of a composite absorbent material produced according to the method of the present invention is generally designated 1. On the surface of the material are indicated a multitude of regularly spaced weld-points 2 at which the multiple layers of the composite absorbent material 1 are joined by ultrasonic welding. Depending on the conditions used during the ultrasonic welding process, the composite absorbent material 1 may also be punctured at these weld-points 2, which therefore constitute perforations in the material 1.

It should be appreciated that the spacing between the weld points may be varied according to the desired properties of the composite absorbent material. A greater density of weld points increases the strength of the composite absorbent material, but may restrict the swelling of the absorbent layer as it takes up fluid. The restriction of swelling is particularly undesirable for composite absorbent materials having an inner absorbent layer sandwiched between two reinforcing layers as depicted in FIG. 2B.

Referring now to FIG. 2A, a specific embodiment of the composite absorbent material produced according to this invention is generally designated 10. In this layer of composite absorbent material 10, a superabsorbent layer 6 is welded to both major surfaces of a reinforcing layer 4 such that the latter is sandwiched between those superabsorbent layers 6. Therefore, in this embodiment of the invention, the outer layers of the composite absorbent material 10 are superabsorbent layers 6, and the inner layer is a reinforcing layer 4.

This specific embodiment of the composite absorbent material 10 is most suitable for superabsorbent layers that maintain some mechanical strength upon fluid absorption, such as calcium or sodium alginate, and are therefore less prone to detaching from the reinforcing layer 4.

Referring now to FIG. 2B, another specific embodiment of the composite absorbent material produced according to this invention is generally designated 20. In this layer of composite absorbent material 20, a reinforcing layer 4 is welded to both major surfaces of a superabsorbent layer 6, such that the latter is sandwiched between those reinforcing layers 4. Therefore, in this embodiment of the invention, the outer layers of the composite absorbent material 20 are reinforcing layers 4, and the inner layer is a superabsorbent layer 6.

In this case, the reinforcing layers 4 are not only attached to the superabsorbent layer 5 at the weld-points 2, but are also attached to each other, thereby encapsulating the superabsorbent layer 5. The integrity of the composite absorbent material 20 is therefore not reliant on the superabsorbent layer, meaning this arrangement is able to remain intact even if the superabsorbent material completely loses its integrity.

This embodiment of the composite absorbent material is therefore most suited for the reinforcement of superabsorbent materials that become particularly weakened upon fluid absorption, such as sodium polyacrylate.

This embodiment of the composite absorbent material is also particularly suited to the inclusion of optional additional internal layers 7, such as layers incorporating carbonised deodorising material or anti-microbial material, or external layers 8, such as an impermeable film. The structure of this embodiment of the composite absorbent material produced according to this invention allows multiple inner layers to be securely encapsulated between the two outer reinforcing layers 4.

Although the specific embodiments of the composite absorbent material produced according to this invention shown in FIGS. 2A and 2B comprise a single inner layer sandwiched between two similar outer layers, it should be appreciated that the method of the present invention may produce a composite absorbent material comprising numerous superabsorbent layers and reinforcing layers, and with the two outer layers being different.

Referring now to FIG. 3, an apparatus for carrying out the method of the present invention is generally designated 30. The apparatus is depicted as being adapted to produce the specific embodiments of the composite absorbent material depicted in FIG. 2A or 2B. The apparatus 30 possesses an ultrasonic welding assembly generally designated 40, having a pin-roller 44 which has a cylindrical barrel with a multitude of flat tipped pin-like projections on the circumferential surface, and a sonotrode 42, which produces high frequency mechanical vibrations. The pin-roller 44 and sonotrode 42 are configured so that when the pin-roller 44 is rotated, the tips of the pin-like projections pass close to the surface of the sonotrode 42.

In operation, the inner layer 34 is discharged from roller 34a and the outer layers 32 are discharged from rollers 32a on either side of the inner layer 34, causing the inner layer 34 to be sandwiched between the two outer layers 32, thereby forming a layered arrangement 36. The inner layer 34 of the layered arrangement 36 may be either a superabsorbent layer 6 or a reinforcing layer 4. The outer layers 32 are reinforcing layers 4 where the inner layer 34 is a superabsorbent layer 6, and are superabsorbent layers 6 where the inner layer 34 is a reinforcing layer 4.

This layered arrangement 36 is drawn into the nip between the pin-roller 44 and the sonotrode 42 by the rotation of the pin-roller 44. At the point where the pin-roller 44 is closest to the sonotrode 42, the pins act as points of compression between the pin-roller 44 and the sonotrode 42, where the layered arrangement 36 is welded together to form composite absorbent material 1 depicted in FIG. 1. The composite absorbent material may then be wound onto a roll for supply to an end user or for storage as an intermediate product prior to use of the composite absorbent material in the manufacture of a finished product.

The position of the pin-roller 44 in relation to the sonotrode 42 may be adjusted in order to vary the pressure between the tips of the pins and the sonotrode 42 when the apparatus 30 is in operation. This may result in the variation of the strength of welding and potentially produce perforations in the material at the weld-points 2.

1. A method of producing a composite absorbent material, which method involves forming a layered arrangement of one or more absorbent layers and one or more reinforcing layers, and using high frequency mechanical vibrations to weld at least two of the layers together in order to produce a composite absorbent material.

2. A method as claimed in claim 1, wherein the layered arrangement comprises multiple absorbent layers and/or multiple reinforcing layers.

3. A method as claimed in claim 2, wherein the layered arrangement comprises no more than two absorbent layers and no more than two reinforcing layers.

4. A method as claimed in claim 2, wherein the absorbent layers and reinforcing layers in the layered arrangement alternate so each layer is adjacent only to dissimilar layers.

5. A method as claimed in claim 2, wherein the layered arrangement comprises three layers, wherein there is an inner layer sandwiched between two outer layers that are dissimilar to the inner layer and similar to each other.

6. A method as claimed in claim 1, wherein the layered arrangement is held between a support surface having a multitude of projections, and a sonotrode that applies the high frequency mechanical vibrations.

7. A method as claimed in claim 6, wherein the layered arrangement is held under pressure between the tips of the projections projecting from the support surface and the sonotrode.

8. A method as claimed in claim 6, wherein the support surface takes the form of a roller, with the projections projecting from its circumferential surface.

9. A method as claimed in claim 1, wherein the at least two layers are fused together at a plurality of weld points.

10. A method as claimed in claim 9, wherein the weld points are regularly arranged with a separation that is substantially greater than their diameter.

11. A method as claimed in claim 9, wherein the weld points have a separation of between 5 mm and 30 mm, or between 20 mm and 30 mm, or between 10 mm and 15 mm.

12. A method as claimed claim 9, wherein the weld points have a diameter of between 0.5 mm and 2 mm.

13. A method as claimed in claim 1, wherein the reinforcing layer or layers are formed of a non-woven material.

14. A method as claimed in claim 1, wherein the reinforcing layer or layers are formed of material that fuses when heated.

15. A method as claimed in claim 1, wherein the absorbent layer or layers includes a superabsorbent material.

16. A method as claimed in claim 15, wherein the superabsorbent material is a polyacrylate.

17. A method as claimed in claim 16, wherein the polyacrylate is in solid crystalline form.

18. A method as claimed in claim 15, wherein the superabsorbent material is calcium alginate or sodium alginate.

19. A method as claimed in claim 18, wherein the calcium alginate or sodium alginate is in the form of a non-woven mat.

20. A method as claimed in claim 1, wherein the method further comprises a final step of sterilising the material.

21. A method as claimed in claim 1, wherein the layered arrangement further comprises an additional layer or layers.

22. A method as claimed in claim 21, wherein the layered arrangement further comprises a layer of carbonised deodoriser.

23. A method as claimed in claim 21, wherein the layered arrangement further comprises an antimicrobial agent.

24. A method as claimed in claim 23, wherein the antimicrobial agent is silver.

25. A method as claimed in claim 21, wherein the layered arrangement further comprises a layer of impermeable film.

26. A method as claimed in claim 25, wherein the impermeable film is a polyurethane film.

27. A composite absorbent material comprising a layered arrangement of one or more absorbent layers and one or more reinforcing layers, in which at least two of the layers are welded together at a plurality of weld points.

28. A material as claimed in claim 27, wherein the layered arrangement comprises multiple absorbent layers and/or multiple reinforcing layers.

29. A material as claimed in claim 28, wherein the layered arrangement comprises no more than two absorbent layers and no more than two reinforcing layers.

30. A material as claimed in claim 28, wherein the absorbent layers and reinforcing layers in the layered arrangement alternate so each layer is adjacent only to dissimilar layers.

31. A material as claimed in claim 28, wherein the layered arrangement comprises three layers, wherein there is an inner layer sandwiched between two outer layers that are dissimilar to the inner layer and similar to each other.

32. A material as claimed in claim 27, wherein the weld points are regularly arranged with a separation that is substantially greater than their diameter.

33. A material as claimed in claim 27, wherein the weld points have a separation of between 5 mm and 30 mm, or between 20 mm and 30 mm, or between 10 mm and 15 mm.

34. A material as claimed in claim 27, wherein the weld points have a diameter of between 0.5 mm and 2 mm.

35. A material as claimed in claim 27, wherein the reinforcing layer or layers are formed of a non-woven material.

36. A material as claimed in claim 27, wherein the reinforcing layer or layers are formed of material that fuses when heated.

37. A material as claimed in claim 27, wherein the absorbent layer or layers include a superabsorbent material.

38. A material as claimed in claim 37, wherein the superabsorbent material is a polyacrylate.

39. A material as claimed in claim 38, wherein the polyacrylate is in solid crystalline form.

40. A material as claimed in claim 37, wherein the superabsorbent material is calcium alginate or sodium alginate.

41. A material as claimed in claim 40, wherein the calcium alginate or sodium alginate is in the form of a non-woven mat.

42. A material as claimed in claim 27, wherein the material is sterile.

43. A material as claimed in claim 27, wherein the layered arrangement further comprises an additional layer or layers.

44. A material as claimed in claim 43, wherein the layered arrangement further comprises a layer of carbonised deodoriser.

45. A material as claimed in claim 43, wherein the layered arrangement further comprises an antimicrobial agent.

46. A material as claimed in claim 45, wherein the antimicrobial agent is silver.

47. A material as claimed in claim 43, wherein the layered arrangement further comprises a layer of impermeable film.

48. A material as claimed in claim 47, wherein the impermeable film is a polyurethane film.
